(19) United States
(12) Patent Application Publication
(10) Pub. No.: US 2009/0310462 A1
(43) Pub. Date: Dec. 17, 2009

(54) FRUSTUM-SHAPED HOLOGRAPHIC DISC AND MATCHING TRAY IN A HOLOGRAPHIC DRIVE

(76) Inventors: Allen Keith Bates, Tucson, AZ (US); Nils Haustein, Soergenloch (DE); Craig A. Klein, Tucson, AZ (US); Daniel J. Winarski, Tucson, AZ (US)

Correspondence Address: INTERNATIONAL BUSINESS MACHINES CORPORATION, 9000 SOUTH RITA ROAD, TUCSON, AZ, 85744, US

(21) Appl. No.: 12/137,285

(22) Filed: Jun. 11, 2008

(51) Int. Cl. G11B 7/00

(52) U.S. Cl. 369/103

(57) ABSTRACT

A holographic disc comprises a multilayer right-circular frustum. The frustum includes a substrate layer having an inner surface and an outer surface. A reflective track layer is formed on the inner surface of the substrate layer. A first gap layer overlies the reflective track layer. A dichroic mirror layer overlies the first gap layer. A second gap layer overlies the dichroic mirror layer. A holographic recording layer overlies the second gap layer. A cover layer overlies the holographic recording layer. The cover layer has an inner surface in contact with the holographic recording layer and an outer surface. The frustum has a major diameter and a minor diameter. In one embodiment of the multilayer right-circular frustum, the outer surface of the said outer surface of the cover layer defines the minor diameter and the outer surface of the substrate layer defines the major. In another embodiment, the outer surface of the substrate layer defines the minor diameter and the outer surface of said the cover layer defines the major diameter.

### BACKGROUND OF THE INVENTION

1. Technical Field

The present invention relates generally to the field of optical storage devices, more particularly to a frustum-shaped holographic disc and a matching tray in a holographic drive.

2. Description of the Related Art

The holographic disc and disc drive are a recently developed optical disc technology. Holographic discs are accessed via a collinear holographic light path, in which two lasers, one green or blue and the other red, are collimated into a single beam. The blue or green laser reads data encoded as interference fringes from a holographic layer. The red laser is used as reference beam and to read servo information from a reflective track layer.

Holographic disc technology provides tremendous amounts of storage capacity. One holographic disc can hold up to about 3.9 terabytes of information, which is approximately 5,800 times the capacity of standard CD-ROM.

Most holographic discs are single-sided in that they may be written to or read from only one side. However, it is not readily apparent which side is which. If a user is not careful, the user may insert the holographic disc into its drive upside-down. The user is not aware that the disc is upside-down until the drive spins the disc up to speed and cannot read it. The user must then operate the drive to eject the disc and turn it over.

### SUMMARY OF THE INVENTION

Embodiments of the present invention provide a holographic disc and a holographic disc drive system. The disc comprises a multilayer right-circular frustum. The multilayer right-circular frustum includes a substrate layer having an inner surface and an outer surface. A reflective track layer is formed on the inner surface of the substrate layer. A first gap layer overlies the reflective track layer. A dichroic mirror layer overlies the first gap layer. A second gap layer overlies the dichroic mirror layer. A holographic recording layer overlies the second gap layer. A cover layer overlies the holographic recording layer. The cover layer has an inner surface in contact with the holographic recording layer and an outer surface.

The multilayer right-circular frustum has major diameter and a minor diameter. In one embodiment of the multilayer right-circular frustum, the outer surface of the said outer surface of the cover layer defines the minor diameter and the outer surface of the substrate layer defines the major. In another embodiment, the outer surface of the substrate layer defines the minor diameter and the outer surface of said the cover layer defines the major diameter.

Embodiments of the holographic disc drive system of the present invention include a tray. The tray includes a disc receiver. The disc receiver includes frusto-conical surface having a taper substantially equal to the taper of the disc. The major diameter of the frusto-conical surface of the tray is slightly larger than the major diameter of the disc. Similarly, the minor diameter of the frusto-conical surface of the tray is slightly larger than the minor diameter of the disc. The tray includes disc supporting lip that extends inwardly from the minor diameter of the frusto-conical surface. The disc fits in the disc receiver when the disc is right-side up. The disc does not fit in the disc receiver when the disc is upside-down.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is a block diagram of a second embodiment of a system according to the present invention;

FIG. 3 is a top view of an embodiment of a disc according to the present invention;

FIG. 4 is a sectional view taken along line 4-4 of FIG. 3;

FIG. 5 is a top view of the embodiment of a tray according to the present invention;

FIG. 6 is a sectional view taken along line 6-6 of FIG. 5;

FIG. 7 is a sectional view of disc properly fitting in a tray;

FIG. 8 is a sectional view of disc improperly fitting in a tray; and,

FIG. 9 is a sectional view showing details of a holographic disc.

### DETAILED DESCRIPTION OF THE PREFERRED EMBODIMENT

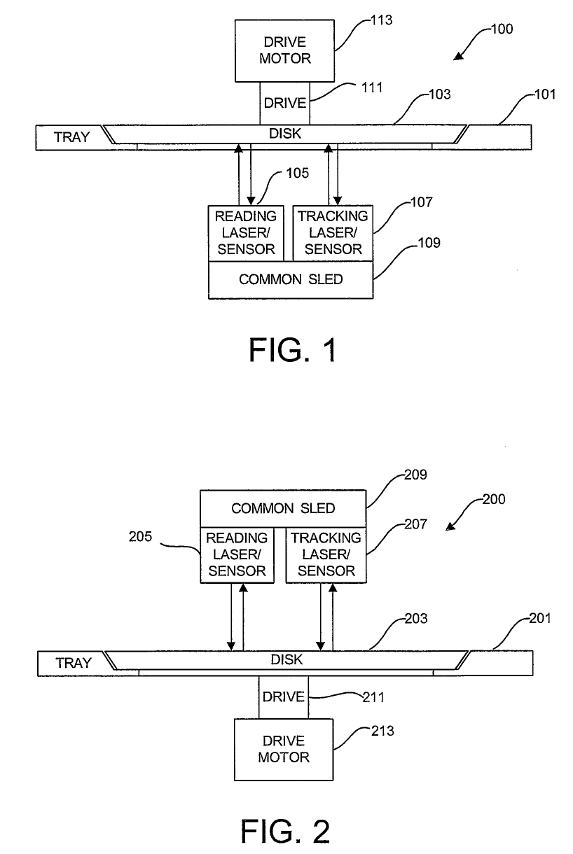

Referring now to the drawings, and first to FIG. 1, a system according to the present invention is designated generally by the numeral 100. System 100 includes a tray 101 which is adapted to receive a disc 103. In the preferred embodiment, disc 103 is a single-sided holographic disc. Disc 103 generally comprises a multilayer right-circular frustum, the internal structure of which will be described in detail with reference to FIG. 9.

In the embodiment of FIG. 1, disc 103 is configured to be read from the bottom. System 100 includes a reading laser/sensor module 105 positioned below disc 103. As is known to those skilled in the art, reading laser sensor/module 105 includes a blue or green laser and CMOS sensor (neither shown). The laser of reading laser/sensor module 105 is adapted to transmit green or blue laser light upwardly into disc 103. The CMOS sensor of reading laser/sensor module 105 is adapted to receive green or blue laser light reflected back from a dichroic mirror layer (909 of FIG. 9) of disc 103. System 100 also includes a tracking laser/sensor module 107 positioned below disc 103. As is known to those skilled in the art, tracking laser/sensor module 107 includes a red laser and CMOS sensor (neither shown). The laser of tracking laser/sensor module 107 is adapted to transmit red laser light upwardly into disc 103. The CMOS sensor of tracking laser/sensor module 107 is adapted to receive red laser light reflected back from reflective tracks (905 of FIG. 9) of disc 103. Reading laser sensor module 105 and tracking laser sensor module 107 are carried by a common sled 109 positioned below disc 103.

System 100 also includes a drive mechanism which includes a drive member 111 and a drive motor 113 coupled to drive member 111. The drive mechanism also includes a mechanism (not shown) for moving drive member 111 into engagement with disc 103. When drive member 111 is engaged with disc 103, drive motor 113 can spin disc 103.

FIG. 2 is a block diagram of an alternative embodiment of a system 200 according to the present invention, in which a disc 203 is configured to be read from the top. System 200 includes a tray 201 which is adapted to receive a disc 203. Disc 203 is preferably a single-sided holographic disc similar to disc 103 except that disc 203 is configured to be read from the top.

System 200 includes a reading laser/sensor module 205 positioned above disc 203. Reading laser sensor/module 205 is similar to reading laser/sensor module 105. The laser (not shown) of reading laser/sensor module 205 is adapted to transmit green or blue laser light downwardly into disc 203. The sensor CMOS (not shown) of reading laser/sensor module 205 is adapted to receive green or blue laser light reflected back from dichroic mirror layer (909 of FIG. 9) of disc 203. System 200 also includes a tracking laser/sensor module 207, which is similar to tracking laser/sensor module 107, positioned above disc 203. The laser (not shown) of tracking laser/sensor module 207 is adapted to transmit red laser light downwardly into disc 203. The CMOS sensor (not shown) of tracking laser/sensor module 207 is adapted to receive red laser light reflected back from reflective tracks (905 of FIG. 9) of disc 203. Reading laser sensor module 205 and tracking laser sensor module 207 are carried by a common sled 209 positioned above disc 203.

A drive mechanism includes a drive member 211 and a drive motor 213 coupled to drive member 211. The drive mechanism also includes a mechanism (not shown) for moving drive member 211 into engagement with disc 203. When drive member 211 is engaged with disc 203, drive motor 213 can spin disc 203.

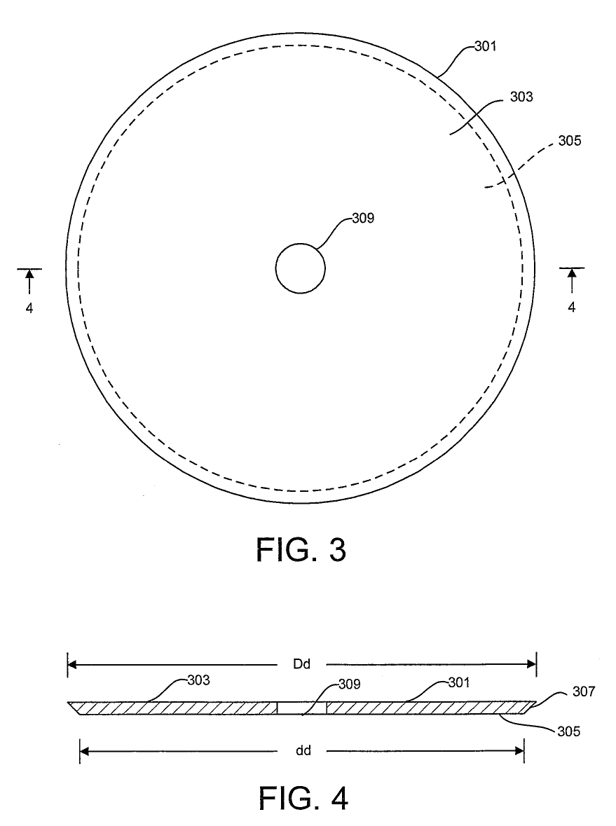

FIGS. 3 and 4 illustrate an embodiment of a disc 301 according to the present invention. Disc 301 is in the form of a right-circular truncated cone or frustum. Disc 301 includes a top surface 303 and a parallel opposing bottom surface 305. Top surface 303 defines a major diameter Dd of disc 301. Bottom surface 305 defines a minor diameter dd of disc 301, which is smaller than major diameter Dd. The edge of 307 of disc 301 between top surface 303 and bottom surface 305 is thus tapered between minor diameter dd and major diameter Dd. A hole 309 penetrates the center of disc 301. Hole 309 is adapted to be engaged by drive member 111, in the embodiment of the system of FIG. 1, or drive member 211, in the embodiment of FIG. 2.

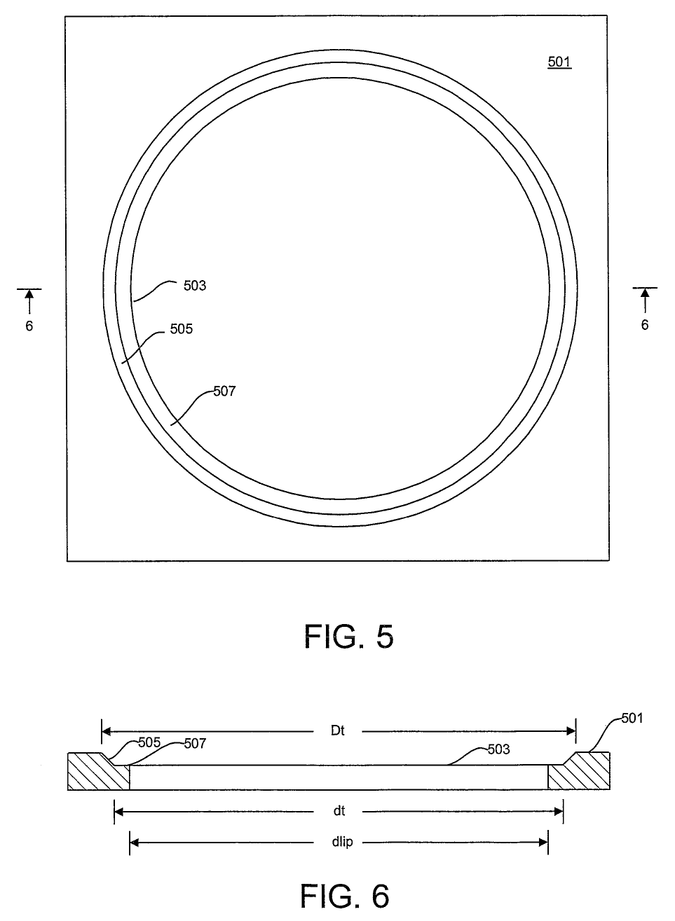

FIGS. 5 and 6 illustrate an embodiment of a tray 501 according to the present invention. Tray 501 includes a disc receiver 503. Disc receiver 503 includes an upwardly facing right-circular frusto-conical surface 505. Frusto-conical surface 505 tapers outwardly from a minor diameter dt toward a major diameter Dt, which is larger than minor diameter dt. The taper of frusto-conical surface 505 is substantially equal to the taper of edge 307 of disc 301. Minor diameter dt of frusto-conical surface 505 is slightly larger than minor diameter dd of disc 301. Similarly, major diameter Dt of frusto-conical surface 505 is slightly larger than major diameter Dd of disc 301. An annular disc support lip 507 extends inwardly from minor diameter dt toward the center of tray 501. Disc support lip 507 comprises a ring having an inside diameter dlip that is less than minor diameter dd of disc 301.

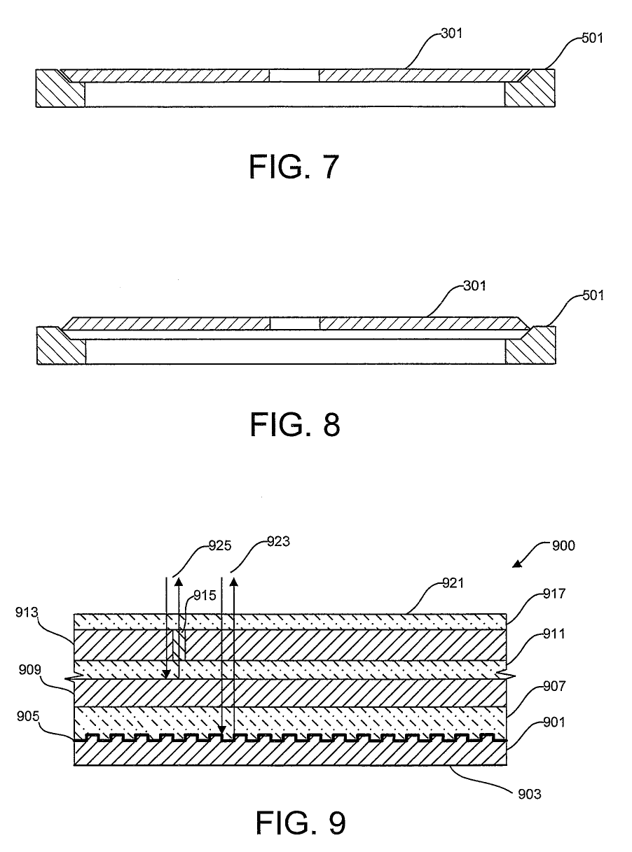

FIGS. 7 and 8 illustrate the cooperation of disc 301 and tray 501 according to the present invention. In FIG. 7, disc 301 is received in disc receiver 503 of tray 501. The frusto-conical edge 307 mates with frusto-conical surface 505 of disc receiver 503. The outer portion of bottom surface 305 of disc 301 rests on disc support lip 507 of tray 501. In FIG. 8, however, disc 301 is upside-down and does not fit properly into disc receiver 503. Thus, a user can tell immediately whether disc 301 is properly inserted and thereby save the time and trouble of spinning up the disc only to find out the disc is upside-down.

FIG. 9 is a magnified sectional view of a holographic disc 900. Disc 900 includes a transparent base or substrate layer 901. Substrate layer includes an outer surface 903. Outer surface 903 may correspond to the top surface of disc 103 in the embodiment of FIG. 1 or the bottom surface of disc 201 in the embodiment of FIG. 2. The inner surface of substrate layer 903 is stamped to form reflective tracks 905 which are covered with a reflective layer of aluminum, gold, silicon, silver, or the like. Reflective tracks 905 may comprise concentric rings or a continuous spiral. A transparent gap layer 907 overlies tracks 905 and its reflective layer. A dichroic mirror layer 909 overlies gap layer 907 so that light from the laser sensor/module 105 and reading laser/sensor module 205 cannot access tracks 905. A second transparent gap layer 911 overlies dichroic mirror layer 909. A photopolymeric data recording layer 913 overlies second gap layer 909. Data in the form of a hologram 915 is recorded in data recording layer 913. Data recording layer 913 is covered by a polycarbonate cover layer 917. Cover layer 917 includes an outer surface 921. Outer surface 921 may correspond to the bottom surface of disc 103, in the embodiment of FIG. 1, or the top surface of disc 203 in the embodiment of FIG. 2.

Dichroic mirror layer 909 is transparent to red laser light but reflective of blue or green laser light. Thus red laser light, indicated by arrows 923, passes through dichroic mirror layer 909 to be reflected back from reflective track layer 905. Green or blue laser light indicated by arrows 925, is reflected back from dichroic layer 909.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. For example, reading laser sensor/module 105 and reading laser/sensor module 205 may be configured for both writing as well as reading. Accordingly, the foregoing description is intended for purposes of illustration and not of limitation.

What is claimed is:

1. A holographic disc, which comprises:
a multilayer right-circular frustum including:
a substrate layer, said substrate layer having an inner surface and an outer surface;
a reflective track layer formed on the inner surface of said substrate layer;
a first gap layer overlying said reflective track layer;
a dichroic mirror layer overlying said first gap layer;
a second gap layer overlying said dichroic mirror layer;
a holographic recording layer overlying said second gap layer; and,
a cover layer overlying said holographic recording layer, said cover layer having an inner surface in contact with said holographic recording layer and an outer surface.

2. The holographic disc as claimed in claim 1, wherein:
said outer surface of said cover layer defines a minor diameter of said right-circular frustum; and,
said outer surface of said substrate layer defines a major diameter of said right-circular frustum.

3. The holographic disc as claimed in claim 1, wherein:
said outer surface of said substrate layer defines a minor diameter of said right-circular frustum; and,
said outer surface of said cover layer defines a major diameter of said right-circular frustum.

4. A holographic disc drive, which comprises:
a tray, said tray including a disc receiver, said disc receiver including an inwardly extending lip and a right-circular frusto-conical surface, said frusto-conical surface tapering upwardly from a minor diameter adjacent said lip to a major diameter;
a reading laser/sensor positioned adjacent said tray;
a tracking laser/sensor positioned adjacent said tray; and,
a drive mechanism positioned adjacent said tray, said drive mechanism including a drive member engageable with a disc positioned in said tray and a drive motor coupled to said drive member.

5. The holographic disc driver as claimed in claim 4, wherein:
said reading laser/sensor and said tracking laser/sensor are positioned beneath said tray.

6. The holographic disc drive as claimed in claim 5, wherein:
said drive mechanism is positioned above said tray.

7. The holographic disc drive as claimed in claim 4, wherein:
said reading laser/sensor and said tracking laser sensor are positioned above said tray.

8. The holographic disc drive as claimed in claim 5, wherein:
said drive mechanism is positioned beneath said tray.

9. The holographic disc drive as claimed in claim 4, wherein said lip comprises:
a ring extending inwardly from said minor diameter of said frusto-conical surface.

10. The holographic disc drive as claimed in claim 4, including:
a holographic disc positioned in said disc receiver of said tray, said holographic disc comprising a right-circular frustum having a major diameter greater than the minor diameter of said frusto-conical surface of said disc receiver and a minor diameter less than said minor diameter of said frusto-conical surface of said disc receiver.

11. The holographic disc drive as claimed in claim 10, wherein said lip comprises:
a ring extending inwardly from said minor diameter of said frusto-conical surface of said disc receiver, said ring having an inside diameter less than the minor diameter of said holographic disc.

12. The holographic disc drive as claimed in claim 10, wherein said holographic disc comprises:
a substrate layer, said substrate layer having an inner surface and an outer surface;
a reflective track layer formed on the inner surface of said substrate layer;
a first gap layer overlying said reflective track layer;
a dichroic mirror layer overlying said first gap layer;
a second gap layer overlying said dichroic mirror layer;
a holographic recording layer overlying said second gap layer; and,
a cover layer overlying said holographic recording layer, said cover layer having an inner surface in contact with said holographic recording layer and an outer surface.

13. The holographic disc drive as claimed in claim 12, wherein:
said outer surface of said cover layer defines said minor diameter of said right-circular frustum; and,
said outer surface of said substrate layer defines said major diameter of said right-circular frustum.

14. The holographic disc drive as claimed in claim 13, wherein:
said reading laser/sensor and said tracking laser/sensor are positioned beneath said tray.

15. The holographic disc drive as claimed in claim 12, wherein:
said outer surface of said substrate layer defines said minor diameter of said right-circular frustum; and,
said outer surface of said cover layer defines said major diameter of said right-circular frustum.

16. The holographic disc drive as claimed in claim 15, wherein:
said reading laser/sensor and said tracking laser sensor are positioned above said tray.
